(19) United States
(12) Patent Application Publication
(10) Pub. No.: US 2025/0282292 A1
(43) Pub. Date: Sep. 11, 2025

(54) VEHICLE DISPLAY DEVICE AND IMAGE DISPLAY METHOD

(71) Applicant: YAZAKI CORPORATION, Tokyo (JP)

(72) Inventors: Masanobu Takeda, Shimada-shi (JP); Katsuyoshi Kameyama, Shimada-shi (JP); Mayumi Miller, Shimada-shi (JP)

(21) Appl. No.: 19/218,190

(22) Filed: May 23, 2025

Related U.S. Application Data
(63) Continuation of application No. PCT/JP2023/044599, filed on Dec. 13, 2023.

(30) Foreign Application Priority Data
Dec. 27, 2022 (JP) 2022-209268

(51) Int. Cl. B60R 1/26

(52) U.S. Cl. CPC B60R 1/26; B60R 2300/8093

(57) ABSTRACT

A vehicle display device includes: an image acquisition unit that acquires a peripheral image being an image obtained by imaging a peripheral region of a vehicle, the peripheral region including a rear region of the vehicle; and a display device that displays the peripheral image in a display region in a windshield of the vehicle, and the display region is an upper region in the windshield, and is a region that is continuous from one end to another end in a vehicle width direction in the windshield.

### CROSS-REFERENCE TO RELATED APPLICATION(S)

This application is a continuation application of International Application No. PCT/JP2023/044599 filed on Dec. 13, 2023 which claims the benefit of priority from Japanese Patent Application No. 2022-209268 filed on Dec. 27, 2022 and designating the U.S., the entire contents of which are incorporated herein by reference.

### BACKGROUND OF THE INVENTION

### 1. Field of the Invention

The present invention relates to a vehicle display device and an image display method.

### BACKGROUND

### 2. Description of the Related Art

Conventionally, a technique for displaying an image on a windshield has been proposed. JP 2020-011 586 A discloses a vehicle windshield structure that enables a video indicating a rear side of a vehicle to be visually recognized with satisfaction even in a case where the periphery of the vehicle is bright. The vehicle windshield structure of JP 2020-011 586 A is provided on a vehicle upper side in a windshield, and includes a display unit that is transparent and on which the video indicating the rear side of the vehicle is displayed, and a light shielding member that shields, from light, a region including the display unit in the windshield in a case where the periphery of the vehicle has brightness that is greater than predetermined brightness.

It is desirable that an amount of movement of a line of sight can be reduced in a case where a driver checks the periphery of the vehicle including the rear side of the vehicle. For example, in a case where a mirror that indicates the rear side of the vehicle is located apart from a mirror that indicates a diagonally rear side of the vehicle, a line of sight greatly moves to check the periphery.

### SUMMARY OF THE INVENTION

It is an object of the present invention to provide a vehicle display device and an image display method that can reduce an amount of movement of a line of sight of a driver in a case where the driver checks the periphery of a vehicle including a rear side of the vehicle.

In order to achieve the above mentioned object, a vehicle display device according to one aspect of the present invention includes an image acquisition unit that acquires a peripheral image being an image obtained by imaging a peripheral region of a vehicle, the peripheral region including a rear region of the vehicle; a display device that displays the peripheral image in a display region in a windshield of the vehicle; and a generation unit that generates a caution image being an image for cautioning against a target to be careful about that is included in the peripheral image, wherein the display region is an upper region in the windshield, and is a region that is continuous from one end to another end in a vehicle width direction in the windshield, the target to be careful about at the time of backward movement of the vehicle is an object that is present on a route behind the vehicle or an object that is present near the route, the target to be careful about at the time of a forward movement of the vehicle is an object that is approaching to the vehicle from a rear side, and the display device displays the peripheral image and the caution image in the display region.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating a display device according to an embodiment;

FIG. 2 is a sectional view illustrating the display device according to the embodiment;

FIG. 3 is a diagram illustrating a display region according to the embodiment;

FIG. 4 is a block diagram of a vehicle display device according to the embodiment;

FIG. 5 is a diagram explaining an imaging range according to the embodiment;

FIG. 6 is a diagram illustrating an example of a peripheral image according to the embodiment;

FIG. 7 is a diagram illustrating an example of the peripheral image according to the embodiment;

FIG. 8 is a flowchart relating to an image display method according to the embodiment;

FIG. 9 is a diagram illustrating the peripheral image and a caution image according to the embodiment;

FIG. 10 is a diagram illustrating an example of a camera according to the embodiment; and

FIG. 11 is a diagram illustrating a schematic configuration of a display device according to a variation of the embodiment.

### DETAILED DESCRIPTION OF THE PREFERRED EMBODIMENTS

A vehicle display device and an image display method according to an embodiment of the present invention will be described in detail below with reference to the drawings. Note that this embodiment is not restrictive of this invention. Furthermore, components in the embodiment described below include components that those skilled in the art could easily conceive of, or substantially the same components.

### EMBODIMENT

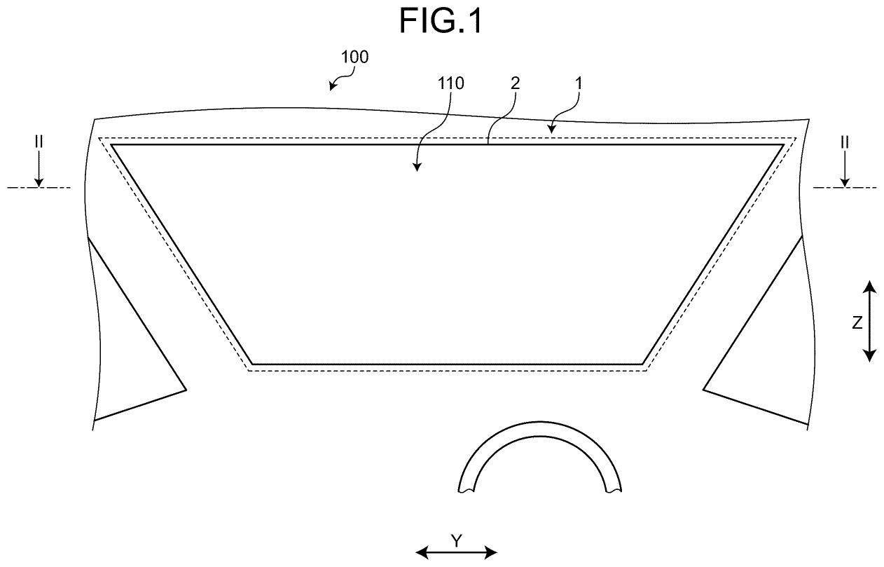

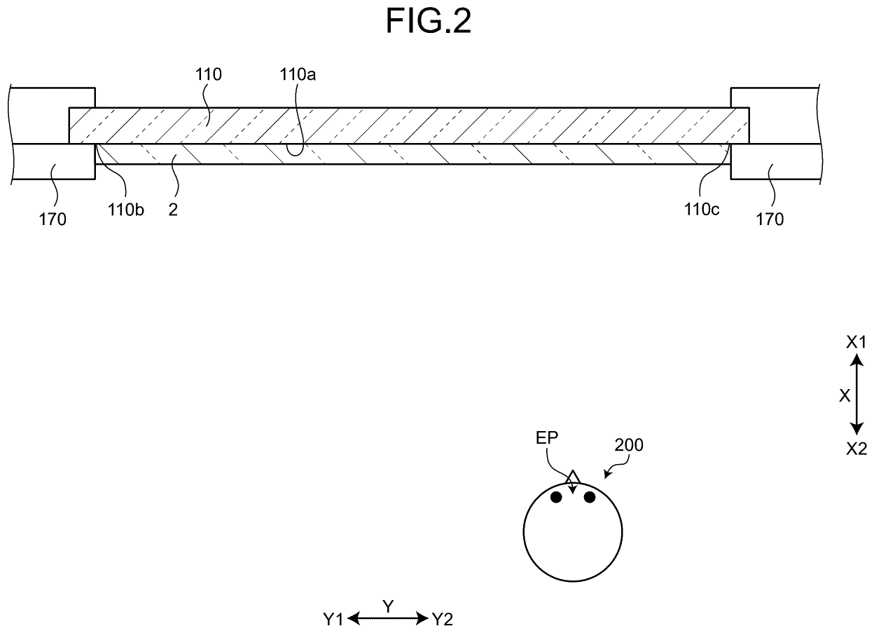

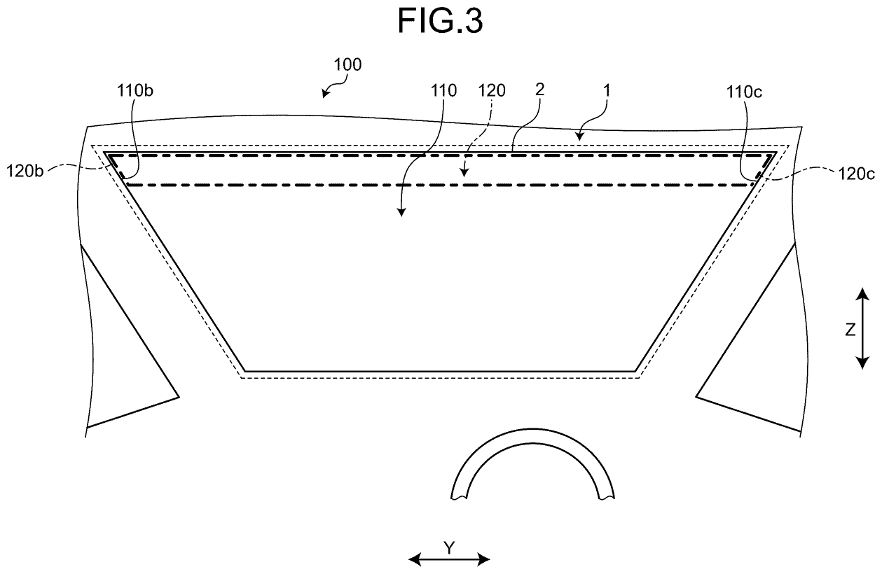

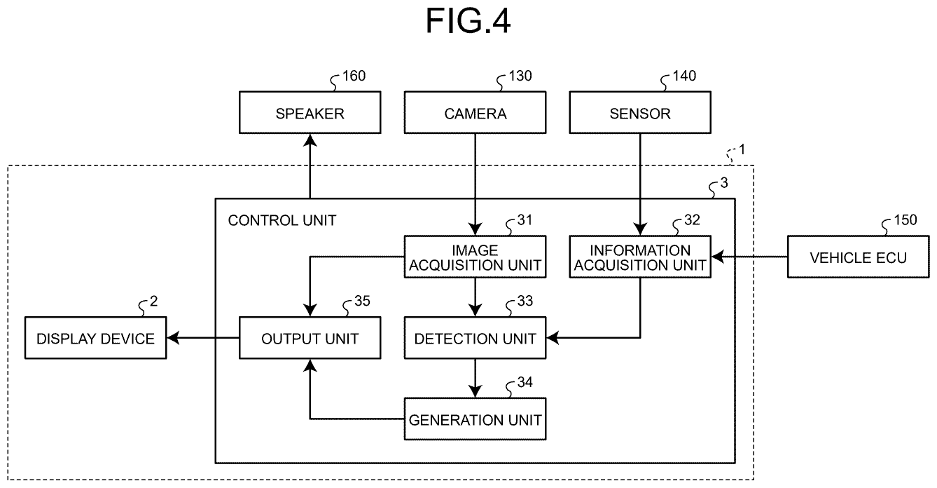

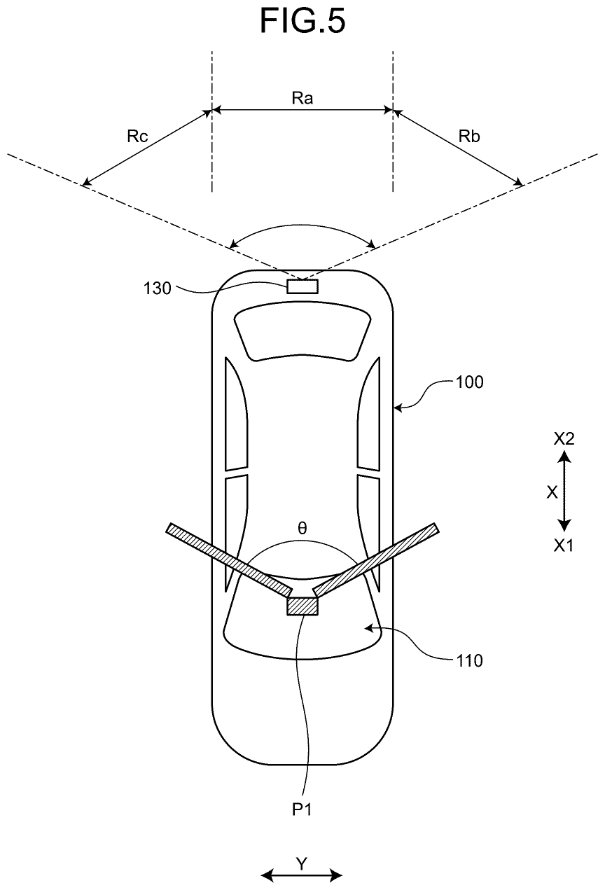

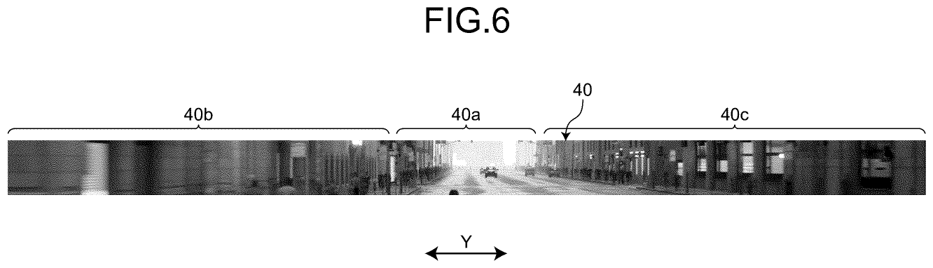

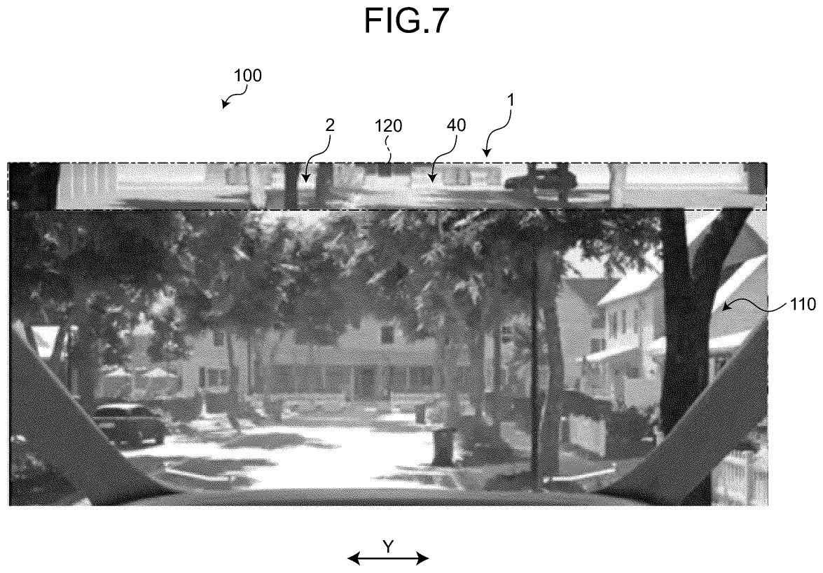

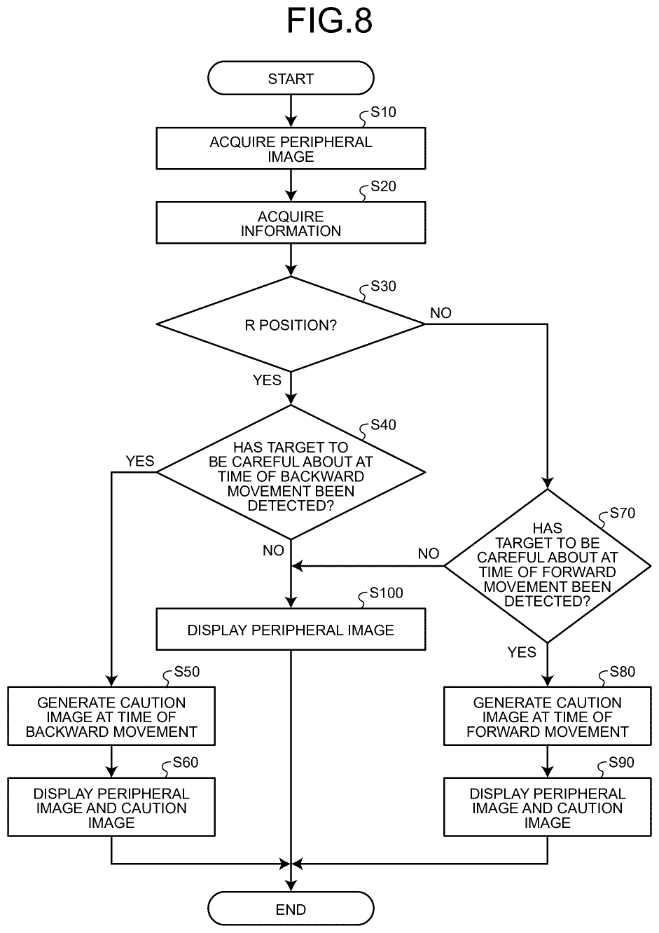

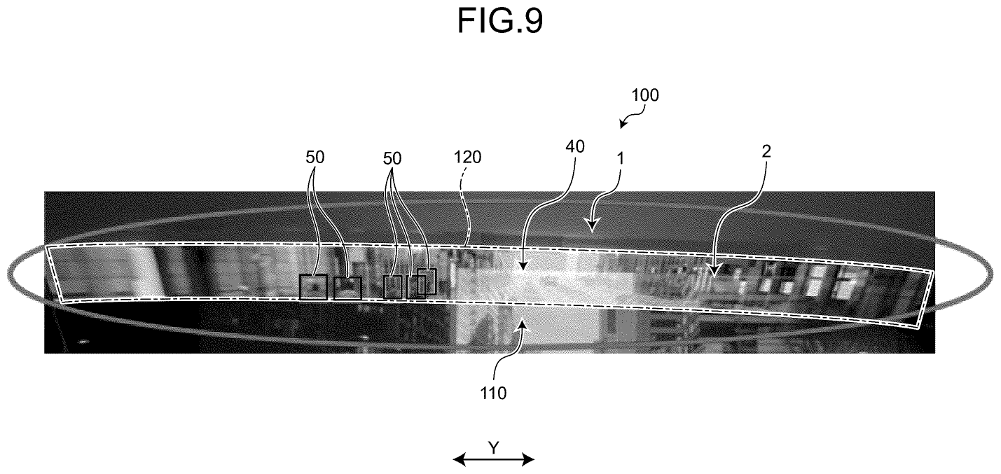

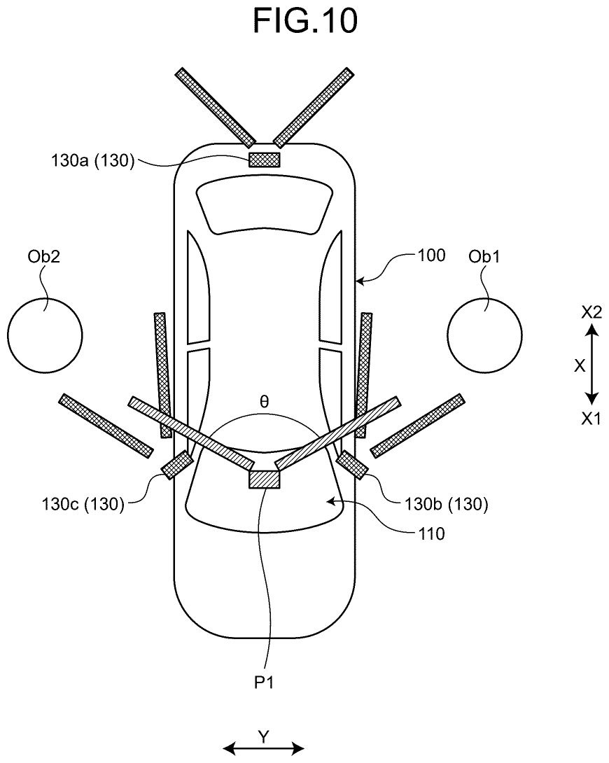

An embodiment will be described with reference to FIGS. 1 to 10. The present embodiment relates to a vehicle display device and an image display method. FIG. 1 is a diagram illustrating a display device according to the embodiment, FIG. 2 is a sectional view illustrating the display device according to the embodiment, FIG. 3 is a diagram illustrating a display region according to the embodiment, FIG. 4 is a block diagram of a vehicle display device according to the embodiment, FIG. 5 is a diagram explaining an imaging range according to the embodiment, FIGS. 6 and 7 are diagrams illustrating an example of a peripheral image according to the embodiment, FIG. 8 is a flowchart relating to an image display method according to the embodiment, FIG. 9 is a diagram illustrating the peripheral image and a caution image according to the embodiment, and FIG. 10 is a diagram illustrating an example of a camera according to the embodiment. FIG. 2 illustrates cross section II-II of FIG. 1.

FIG. 1 illustrates a display device 2 according to the present embodiment. The display device 2 according to the present embodiment is a display device that has a transparent film shape and is disposed in a windshield 110 of a vehicle 100. The display device 2 is a light-emitting display, and is, for example, an organic EL display (OLED). The illustrated display device 2 is disposed over the entire face of the windshield 110. The display device 2 is disposed, for example, on an inner face 110a in the windshield 110, as illustrated in FIG. 2. The inner face 110a is a face on a rear side X2 in a vehicle forward/backward direction X in the windshield 110, and is a face that faces a driver 200. Note that a position of the display device 2 is not limited to the inner face 110a. The display device 2 may be disposed, for example, in a laminated glass included in the windshield 110.

As illustrated in FIG. 2, an edge of the windshield 110 according to the present embodiment adheres to a vehicle body 170 of the vehicle 100, and is held by the vehicle body 170. The display device 2 is disposed to cover the windshield 110 from one end 110b to another end 110c in a vehicle width direction Y. Here, the one end 110b and the other end 110c of the windshield 110 are boundaries of a region that is exposed to a vehicle interior side. Stated another way, the display device 2 covers the entirety from a left-hand end to a right-hand end of a portion that is visually recognized by the driver 200 in the windshield 110. Similarly, the display device 2 covers the entirety from an upper end to a lower end of the windshield 110. Stated another way, the display device 2 covers the entire face of the region that is visually recognized by the driver 200 in the windshield 110. Note that, for the reasons of mounting on the vehicle 100, the display device 2 may be disposed in such a way that the one end 110b and the other end 110c are exposed. Stated another way, there may be a slight clearance between the vehicle body 170 and the display device 2.

A vehicle display device 1 according to the present embodiment causes the display device 2 to display an image in a display region 120 of the windshield 110, as illustrated in FIG. 3. The display region 120 is an upper region in the windshield 110, and is a region that is continuous from one end to another end in the vehicle width direction Y in the windshield 110. It is preferable that one end 120b of the display region 120 match the one end 110b of the windshield 110. It is preferable that another end 120c of the display region 120 match the other end 110c of the windshield 110. The illustrated display region 120 is a single region that is continuous from the one end 110b to the other end 110c of the windshield 110. A shape of the display region 120 is a belt shape that extends in the vehicle width direction Y.

A specific shape of the display region 120 is determined in accordance with a shape of the windshield 110. The shape of the display region 120 is, for example, a trapezoid or a rectangle. In a case where an upper side in the windshield 110 is curved, the display region 120 may be curved to correspond to this side.

FIG. 4 is a block diagram of the vehicle display device 1 according to the present embodiment. The vehicle display device 1 includes the display device 2 and a control unit 3. The control unit 3 is a display control unit that includes a computer including an arithmetic unit and a memory, and an input/output interface. The control unit 3 may be configured as an electronic control unit (ECU). In the memory of the control unit 3, a program or data for performing operations according to the present embodiment has been stored in advance.

The control unit 3 includes an image acquisition unit 31, an information acquisition unit 32, a detection unit 33, a generation unit 34, and an output unit 35. The image acquisition unit 31, the information acquisition unit 32, the detection unit 33, the generation unit 34, and the output unit 35 may be functions that are achieved according to the program, or may be dedicated processing circuits.

The image acquisition unit 31 acquires a peripheral image 40 from a camera 130 equipped in the vehicle 100. The peripheral image 40 is an image obtained by imaging a peripheral region of the vehicle 100 including a rear region of the vehicle 100. FIG. 5 illustrates an example of disposition of the camera 130. The camera 130 illustrated in FIG. 5 is disposed in a rear portion of the vehicle 100, and images the peripheral region of the vehicle 100. More specifically, the camera 130 images a rear region Ra of the vehicle 100, a diagonally left rear region Rb of the vehicle 100, and a diagonally right rear region Rc of the vehicle 100.

An imaging range of the camera 130 is determined on the basis of a rear viewing angle θ illustrated in FIG. 5. The rear viewing angle θ is an angle of a pseudo field of view in a case where a rear side is viewed from a predetermined point P1 of the vehicle 100, and is an angle in a horizontal direction. Stated another way, the rear viewing angle θ corresponds to an angle of view in the horizontal direction of the camera 130 in a case where the camera 130 has been installed at the predetermined point P1. The camera 130 is configured to image at least a region of the rear viewing angle θ in a case where the rear side of the vehicle is viewed from the predetermined point P1 to be able to generate an image indicating the region of the rear viewing angle θ. The predetermined point P1 is, for example, an eye point EP of the vehicle 100. The predetermined point P1 may be a center point of an eye range or a center point of an eye-box of the vehicle 100. The predetermined point P1 may be a point on the windshield 110, and may be, for example, a center point in the vehicle width direction Y in the display region 120.

FIG. 6 illustrates an example of the peripheral image 40 captured by the camera 130. The peripheral image 40 includes a range 40a in which the rear region Ra has been imaged, a range 40b in which the diagonally left rear region Rb has been imaged, and a range 40c in which the diagonally right rear region Rc has been imaged. Stated another way, the peripheral image 40 is a continuous image obtained by imaging a region from a diagonally left rear side to a diagonally right rear side of the vehicle 100. The vehicle display device 1 causes the display device 2 to display the peripheral image 40 in the display region 120.

FIG. 7 illustrates the peripheral image 40 that is displayed in the display region 120 of the windshield 110. The driver 200 can check a situation in a wide region including a diagonally rear side of the vehicle 100 by using the peripheral image 40. A region from the diagonally left rear side to the diagonally right rear side of the vehicle 100 is seamlessly displayed as a single image, and therefore the driver 200 can easily grasp a peripheral situation of the vehicle 100.

In conventional general vehicles, the driver 200 needs to direct a line of sight to mirrors that are different depending on whether a rear side of the vehicle or a diagonally rear side of the vehicle will be checked. Accordingly, in a case where an attempt is made to check a wide range from a diagonally left rear side to a diagonally right rear side of the vehicle, a line of sight needs to greatly move. In contrast to this, the vehicle display device 1 according to the present embodiment enables a wide range to be checked by using a single peripheral image 40. Therefore, the vehicle display device 1 according to the present embodiment can reduce an amount of movement of a line of sight of the driver 200 in checking the peripheral situation.

Furthermore, the vehicle display device 1 according to the present embodiment causes a caution image 50 to be displayed in a case where the peripheral image 40 includes a target to be careful about, as described below. As illustrated in FIG. 4, the information acquisition unit 32 acquires various types of information from a sensor 140 and a vehicle ECU 150. The sensor 140 is a sensor that is disposed in the vehicle 100, and detects the peripheral situation of the vehicle 100. The sensor 140 may include, for example, a LiDAR that detects a direction of and a distance to an object that is present in the periphery, may include a ranging sensor such as a millimeter wave radar, or may include another sensor or a stereoscopic camera.

The information acquisition unit 32 acquires, from the sensor 140, information relating to a direction of an object that is present around the vehicle 100 and a distance from the vehicle 100 to the object. The information acquisition unit 32 may further acquire, from the sensor 140, information relating to a shape of the object or information relating to the speed of movement of the object.

The vehicle ECU 150 is a control device that controls the vehicle 100, and is, for example, an integrated control ECU that performs integrated control on the vehicle 100. The information acquisition unit 32 acquires, from the vehicle ECU 150, information of the vehicle 100. The information acquisition unit 32 acquires, from the vehicle ECU 150, information relating to, for example, the speed of traveling, acceleration, a shift position, a traveling mode, a turn signal, or a steering angle of the vehicle 100. The information acquisition unit 32 may acquire information of route guidance provided by a navigation device from the vehicle ECU 150 or the navigation device.

Note that the information acquisition unit 32 may acquire a detection result of the sensor 140 via the vehicle ECU 150. Furthermore, in a case where the vehicle ECU 150 has information relating to a direction of a peripheral object and a distance to the peripheral object, these pieces of information may be transmitted from the vehicle ECU 150 to the information acquisition unit 32. The information acquisition unit 32 transmits, to the detection unit 33, pieces of information that have been acquired from the sensor 140 and the vehicle ECU 150.

The detection unit 33 detects the target to be careful about that is included in the peripheral image 40. The detection unit 33 performs, for example, image recognition on the peripheral image 40 to extract an object indicated in the peripheral image 40. The detection unit 33 determines whether the extracted object is a candidate object for the target to be careful about. The candidate object includes another vehicle, a moving body such as a pedestrian, or a structure such as a building.

The detection unit 33 determines an object that satisfies predetermined conditions as the target to be careful about from among the detected candidate objects. For example, in a case where the candidate object is another vehicle, the detection unit 33 determines whether the candidate object is the target to be careful about on the basis of the size of the candidate object. In this case, in a case where the size of the candidate object is greater than or equal to a predetermined value, the candidate object may be determined to be the target to be careful about. Similarly, in a case where the candidate object is a pedestrian and in a case where the size of the candidate object is greater than or equal to a predetermined value, the detection unit 33 may determine that the candidate object is the target to be careful about.

The detection unit 33 may determine the target to be careful about on the basis of information acquired from the information acquisition unit 32. In this case, for example, information of a peripheral object that has been acquired from the sensor 140 is associated with the candidate object that has been extracted from the peripheral image 40. The detection unit 33 determines whether the candidate object is the target to be careful about on the basis of sensor information that has been associated with the candidate object.

Here, an operation of the vehicle display device 1 according to the present embodiment will be described with reference to the flowchart of FIG. 8. In Step S10, the image acquisition unit 31 acquires the peripheral image 40 from the camera 130. When Step S10 has been performed, the processing proceeds to Step S20.

In Step S20, the information acquisition unit 32 acquires pieces of information from the sensor 140 and the vehicle ECU 150. When Step S20 has been performed, the processing proceeds to Step S30.

In Step S30, the detection unit 33 determines whether a current shift position is an R position for backward movement. In a case where the determination of Step S30 is affirmative to determine that the current shift position is the R position, the processing proceeds to Step S40, and in a case where the determination is negative, the processing proceeds to Step S70.

In Step S40, the detection unit 33 determines whether a target to be careful about at the time of backward movement has been detected. In a case where the shift position is the R position, an object that is present on a route behind the vehicle 100 or an object that is present near the route is determined as the target to be careful about. The detection unit 33 determines, for each of the extracted candidate objects, whether a candidate object is located on the route of the vehicle 100 or near the route. A candidate object that is located on the route or near the route is registered as the target to be careful about in a list.

The detection unit 33 may determine whether a candidate object is the target to be careful about on the basis of a distance from the vehicle 100 to the candidate object. For example, a candidate object for which a distance from the vehicle 100 is less than or equal to a lower limit value is determined as the target to be careful about. The detection unit 33 may determine whether a candidate object is the target to be careful about on the basis of the speed of the candidate object relative to the vehicle 100. For example, a candidate object for which the speed of approach to the vehicle 100 is greater than or equal to an upper limit value is determined as the target to be careful about. In a case where the determination of Step S40 is affirmative to determine that the target to be careful about has been detected, the processing proceeds to Step S50, and in a case where the determination is negative, the processing proceeds to Step S100.

In Step S50, the generation unit 34 generates the caution image 50 at the time of backward movement. The generation unit 34 generates the caution image 50 on the basis of a detection result of the detection unit 33. The caution image 50 is an image for cautioning against the target to be careful about. FIG. 9 illustrates an example of the caution image 50. The caution image 50 of FIG. 9 is an image that has been generated for a pedestrian that is located behind the vehicle 100. In other words, the caution image 50 of FIG. 9 is an image for cautioning the driver 200 against a pedestrian that is present on a rear side.

The illustrated caution image 50 is a rectangular image that surrounds a pedestrian serving as the target to be careful about. In FIG. 9, caution images 50 that are different in color in accordance with a distance to the target to be careful about are displayed. A caution image 50 of a color having a high degree of caution, for example, red, is displayed for a target to be careful about that is located near the vehicle 100. A caution image 50 of a color having a low degree of caution, for example, yellow green or yellow, is displayed for a target to be careful about that is a little far from the vehicle 100. The generation unit 34 generates the caution image 50 for the target to be careful about that has been detected in Step S40. When Step S50 has been performed, the processing proceeds to Step S60.

In Step S60, the output unit 35 causes the display device 2 to display the peripheral image 40 and the caution image 50. The output unit 35 outputs, to the display device 2, an image to be displayed. For example, the output unit 35 superimposes the caution image 50 acquired from the generation unit 34 onto the peripheral image 40 to generate a composite image. In this case, the output unit 35 outputs the composite image to the display device 2. The output unit 35 according to the present embodiment outputs the peripheral image 40 to the display device 2 without changing an aspect ratio of the peripheral image 40. Stated another way, an image captured by the camera 130 is displayed in the display device 2 in a state where an aspect ratio of the image is maintained. Note that the output unit 35 may correct the peripheral image 40 or the composite image in accordance with the shape of the windshield 110. For example, in a case where the shape of the display region 120 is a trapezoid, correction may be performed to process a rectangular image captured by the camera 130 into a trapezoid image. Note that the control unit 3 may cause a speaker 160 to output sound cautioning against the target to be careful about. When Step S60 has been performed, the flowchart terminates.

In Step S70, the detection unit 33 determines whether a target to be careful about at the time of a forward movement has been detected. In a case where the shift position is not different from the R position or in a case where the shift position is a position for a forward movement, the detection unit 33 detects the target to be careful about at the time of a forward movement. A target to be careful about in this case is an object that is approaching to the vehicle 100 from a rear side. For example, another vehicle that is approaching from a rear side on the same lane as a lane of the vehicle 100 is a candidate object. For example, in a case where the vehicle 100 changes lanes, another vehicle that is traveling on a lane of a movement destination is a candidate object. For example, a motorcycle that is about to pass the vehicle 100 is a candidate object.

From among these candidate objects, an object that satisfies predetermined conditions is determined as the target to be careful about. The predetermined conditions include at least one of, for example, a condition that a distance from the vehicle 100 to another vehicle is less than or equal to a lower limit value and a condition that the speed of approach of another vehicle to the vehicle 100 is greater than or equal to an upper limit value. In a case where the determination of Step S70 is affirmative to determine that the target to be careful about has been detected, the processing proceeds to Step S80, and in a case where the determination is negative, the processing proceeds to Step S100.

In Step S80, the generation unit 34 generates a caution image 50 at the time of a forward movement. The generation unit 34 generates the caution image 50 for the target to be careful about that has been detected in Step S70. The caution image 50 at the time of a forward movement is, for example, a frame-shaped image that surrounds another vehicle. When Step S80 has been performed, the processing proceeds to Step S90.

In Step S90, the output unit 35 causes the display device 2 to display the peripheral image 40 and the caution image 50. The output unit 35 outputs, to the display device 2, a composite image in which the caution image 50 has been superimposed onto the peripheral image 40. When Step S90 has been performed, the flowchart terminates.

In Step S100, the output unit 35 causes the display device 2 to display the peripheral image 40. In this case, the peripheral image 40 that does not include the caution image 50 is displayed in the display region 120, as illustrated in FIG. 7. When Step S100 has been performed, the flowchart terminates.

The vehicle display device 1 according to the present embodiment enables the driver 200 to understand, at a glance, a direction in which the target to be careful about is present within a wide range behind the vehicle 100.

The vehicle display device 1 according to the present embodiment displays a wide rear image in the display region 120. The rear viewing angle θ illustrated in FIG. 5 is, for example, a value from 140° to 180°. It is preferable that the rear viewing angle θ be a value of 140° or more and 150° or less. The peripheral image 40 is captured at such a wide rear viewing angle θ, and this provides the driver 200 with information that is appropriate to check the periphery.

Note that the vehicle display device 1 may acquire the peripheral image 40 from a plurality of cameras 130. The vehicle 100 illustrated in FIG. 10 is equipped with three cameras 130. The cameras 130 include a first camera 130a, a second camera 130b, and a third camera 130c. The first camera 130a is disposed in a rear portion in the vehicle 100, and images a rear side X2 of the vehicle 100. The second camera 130b is disposed in a left-hand side portion in the vehicle 100. The second camera 130b images a left-hand side and a diagonally left rear side of the vehicle 100. The third camera 130c is disposed in a right-hand side portion in the vehicle 100. The third camera 130c images a right-hand side and a diagonally right rear side of the vehicle 100.

The second camera 130b and the third camera 130c are disposed on sides of the windshield 110, and are disposed, for example, in positions that correspond to door mirrors. The second camera 130b is disposed to be able to image an object Ob1 located on a left-hand side of the vehicle 100. The third camera 130c is disposed to be able to image an object Ob2 located on a right-hand side of the vehicle 100.

The image acquisition unit 31 connects a plurality of images acquired from the first camera 130a, the second camera 130b, and the third camera 130c to generate the peripheral image 40. The peripheral image 40 that has been acquired as described above includes the objects Ob1 and Ob2 located on sides of the vehicle 100. Therefore, the driver 200 can confirm the presence of the objects Ob1 and Ob2 located on sides, by using the peripheral image 40.

In a case where a motorcycle that has approached to the vehicle 100 from a rear side passes on a left-hand side or a right-hand side of the vehicle 100, the driver 200 can sequentially check a movement of the motorcycle, by using the peripheral image 40. The driver 200 can view the peripheral image 40 by slightly moving a line of sight from a state of visually recognizing the forward. Therefore, the vehicle display device 1 according to the present embodiment makes it possible to check a rear side of the vehicle or a side of the vehicle with no need of a large movement of a line of sight. Furthermore, the vehicle display device 1 conducts a display in such a way that the caution image 50 is superimposed onto the motorcycle that is about to pass on the side of the vehicle 100. The caution image 50 is displayed in/with a color or brightness that easily attracts attention of the driver 200. Therefore, the driver 200 can grasp a movement of the motorcycle while gazing forward without directing a line of sight to the peripheral image 40.

As described above, the vehicle display device 1 according to the present embodiment includes the image acquisition unit 31 and the display device 2. The image acquisition unit 31 acquires the peripheral image 40. The peripheral image 40 is an image obtained by imaging a peripheral region of the vehicle 100 including a rear region of the vehicle 100. The display device 2 displays the peripheral image 40 in the display region 120 in the windshield 110 of the vehicle 100.

The display region 120 is an upper region in the windshield 110, and is a region that is continuous from one end to another end in the vehicle width direction Y in the windshield 110. The vehicle display device 1 according to the present embodiment displays the peripheral image 40 in a region that is wide in the vehicle width direction Y, and this can reduce a movement of a line of sight of the driver 200 that is required to check the periphery.

The display device 2 according to the present embodiment includes a transparent display that is disposed in the windshield 110. The peripheral image 40 is displayed by this display. This enables the peripheral image 40 to be displayed without obstructing a front field of view of the driver 200.

The peripheral image 40 according to the present embodiment is a continuous image obtained by imaging a region from a diagonally left rear side to a diagonally right rear side of the vehicle 100. An image indicating a wide range, as described above, is displayed, and this effectively reduces a movement of a line of sight at a time when the driver 200 checks the periphery of the vehicle 100.

The peripheral image 40 according to the present embodiment is an image obtained by imaging a region of a rear viewing angle θ serving as an angle of a field of view in the horizontal direction in a case where a rear side is viewed from the predetermined point P1 of the vehicle 100. An angle of the rear viewing angle θ is appropriately set, and this can provide the driver 200 with an appropriate rear field of view.

The peripheral image 40 may be a continuous image obtained by imaging a region from a left-hand side to a right-hand side of the vehicle 100. Such a peripheral image 40 is generated from, for example, images captured by a plurality of cameras 130. The peripheral image 40 includes images indicating sides of the vehicle 100, and this effectively reduces a movement of a line of sight at a time when the driver 200 checks the periphery of the vehicle 100.

The vehicle display device 1 according to the present embodiment includes the generation unit 34. The generation unit 34 generates the caution image 50 serving as an image for cautioning against the target to be careful about that is included in the peripheral image 40. The display device 2 displays the peripheral image 40 and the caution image 50 in the display region 120. The vehicle display device 1 according to the present embodiment displays the caution image 50, and this can call attention of the driver 200 to the target to be careful about.

An image display method according to the present embodiment includes a step of displaying the peripheral image 40 in the display region 120 in the windshield 110 of the vehicle 100. In the flowchart of FIG. 8, the peripheral image 40 is displayed in the display region 120 in Step S60, Step S90, and Step S100. The image display method according to the present embodiment can reduce a movement of a line of sight of the driver 200 that is required to check the periphery.

Note that the position and the shape that are illustrated of the display region 120 are examples, and are not limited to this position and this shape. For example, a length in the vehicle width direction Y of the display region 120 may be determined according to an angle of view of the peripheral image 40 to be displayed. In a case where an enough length to display the peripheral image 40 has been secured, there may be a clearance between the display region 120 and the vehicle body 170.

### Variation of Embodiment

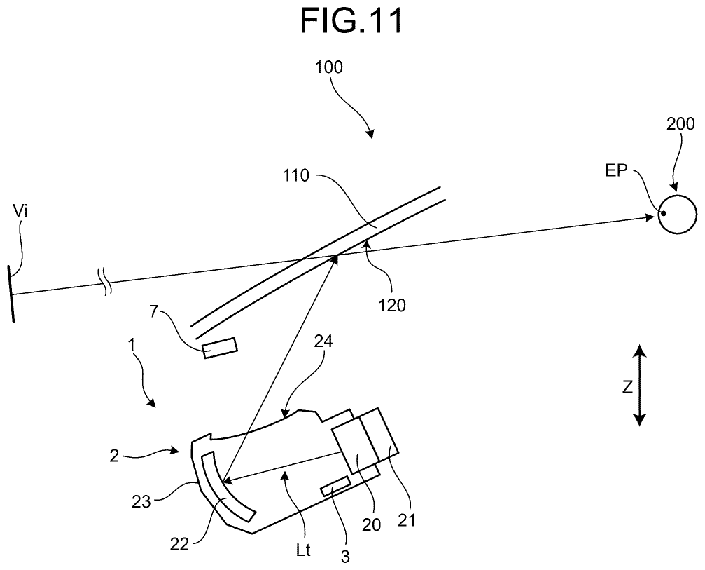

A variation of the embodiment will be described with reference to FIG. 11. FIG. 11 is a diagram illustrating a schematic configuration of a display device according to the variation of the embodiment. A vehicle display device 1 according to the variation of the embodiment is different from the vehicle display device 1 according to the embodiment described above, for example, in that an image is projected onto the display region 120.

As illustrated in FIG. 11, a display device 2 according to the variation of the embodiment is what is called a head-up display device. The display device 2 includes a display unit 20, a backlight unit 21, a mirror 22, a housing 23, and a transparent cover 24. The display unit 20, the backlight unit 21, and the mirror 22 are housed in the housing 23. The cover 24 closes an opening of the housing 23. The opening of the housing 23 faces the windshield 110 in a vehicle upward/downward direction Z.

The display unit 20 is, for example, a liquid crystal display device such as a thin film transistor-liquid crystal display (TFT-LCD). An image of the display unit 20 is output as display light Lt by using light of the backlight unit 21. The mirror 22 reflects the display light Lt toward the display region 120 of the windshield 110. The display light Lt that has been transmitted through the cover 24 is reflected toward the driver 200 by the display region 120. The driver 200 visually recognizes a virtual image Vi by using the display light Lt.

In the vehicle display device 1 illustrated in FIG. 11, a control unit 3 is housed in the housing 23. The control unit 3 acquires the peripheral image 40 to generate the caution image 50 similarly to the control unit 3 according to the embodiment described above. The control unit 3 causes the display unit 20 to display the peripheral image 40 and the caution image 50. This causes the peripheral image 40 and the caution image 50 to be displayed in the display region 120 of the windshield 110.

The virtual image Vi including the peripheral image 40 and the caution image 50 is formed in a position before the windshield 110. Accordingly, a movement of a line of sight is reduced in a case where the driver 200 visually recognizes the peripheral image 40 and the caution image 50, and an amount of adjustment of a focal length is also reduced.

Note that the vehicle display device 1 can adjust a position of projection of the display light Lt in accordance with a detection result of a driver monitor 7. The driver monitor 7 is a camera that images the driver 200. An eye point EP of the driver 200 is detected on the basis of an image captured by the driver monitor 7. The control unit 3 adjusts a direction of projection of the display light Lt in accordance with the detected eye point EP. The adjustment of the direction of projection is achieved, for example, by rotationally moving the mirror 22.

Note that the vehicle display device 1 may include, as the display device 2, the head-up display device according to the variation in addition to the transparent display according to the embodiment. In this case, the peripheral image 40 may be displayed by the transparent display, and the caution image 50 may be displayed by the head-up display device.

Pieces of content disclosed in the embodiment and the variation that have been described above can be appropriately combined and implemented.

### REFERENCE SIGNS LIST

In the vehicle display device according to the present embodiment, the display region of the windshield is an upper region in the windshield, and is a region that is continuous from one end to another end in the vehicle width direction in the windshield. The vehicle display device according to the present embodiment displays, in the display region, an image indicating a wide range of the rear side of the vehicle, and this exhibits an advantageous effect in which an amount of movement of a line of sight of a driver can be reduced in a case where the driver checks the periphery of the vehicle.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A vehicle display device comprising:
an image acquisition unit that acquires a peripheral image being an image obtained by imaging a peripheral region of a vehicle, the peripheral region including a rear region of the vehicle;
a display device that displays the peripheral image in a display region in a windshield of the vehicle; and
a generation unit that generates a caution image being an image for cautioning against a target to be careful about that is included in the peripheral image, wherein
the display region is an upper region in the windshield, and is a region that is continuous from one end to another end in a vehicle width direction in the windshield,
the target to be careful about at the time of backward movement of the vehicle is an object that is present on a route behind the vehicle or an object that is present near the route,
the target to be careful about at the time of a forward movement of the vehicle is an object that is approaching to the vehicle from a rear side, and
the display device displays the peripheral image and the caution image in the display region.

2. The vehicle display device according to claim 1, wherein
the display device includes a display that is transparent and is disposed in the windshield, and
the peripheral image is displayed by the display.

3. The vehicle display device according to claim 1, wherein
the peripheral image is a continuous image obtained by imaging a region from a diagonally left rear side to a diagonally right rear side of the vehicle.

4. The vehicle display device according to claim 3, wherein
the peripheral image is an image obtained by imaging a region of a rear viewing angle being an angle of a field of view in a horizontal direction in a case where a rear side is viewed from a predetermined point of the vehicle.

5. The vehicle display device according to claim 1, wherein
the peripheral image is a continuous image obtained by imaging a region from a left-hand side to a right-hand side of the vehicle.

6. An image display method comprising:
a step of displaying a peripheral image and a caution image being an image for cautioning against a target to be careful about that is included in the peripheral image in a display region in a windshield of a vehicle, wherein
the peripheral image is an image obtained by imaging a peripheral region of the vehicle, the peripheral region including a rear region of the vehicle,
the display region is an upper region in the windshield, and is a region that is continuous from one end to another end in a vehicle width direction in the windshield,
the target to be careful about at the time of backward movement of the vehicle is an object that is present on a route behind the vehicle or an object that is present near the route, and
the target to be careful about at the time of a forward movement of the vehicle is an object that is approaching to the vehicle from a rear side.
